(19) United States
(12) Patent Application Publication
(10) Pub. No.: US 2010/0030901 A1
(43) Pub. Date: Feb. 4, 2010

(54) Methods and Systems for Browser Widgets

(76) Inventors: Bryan Severt Hallberg, Vancouver, WA (US); Renjit Tom Thomas, Vancouver, WA (US); Gregory A. Bartnick, Vancouver, WA (US); Daryl Hlasny, Vancouver, WA (US)

Correspondence Address: Kristine Elizabeth Matthews, 19302 SE 31st Drive, Camas, WA, 98607, US

(21) Appl. No.: 12/181,946

(22) Filed: Jul. 29, 2008

(51) Int. Cl. G06F 15/177

(52) U.S. Cl. 709/228

(57) ABSTRACT

Aspects of the present invention are related to systems and methods for providing and managing browser widgets in systems with limited user interface capabilities or computational power.

### FIELD OF THE INVENTION

Embodiments of the present invention comprise methods and systems for providing and managing browser widgets. In particular, embodiments of the present invention comprise methods and systems suited for providing and managing browser widgets in systems with limited user-interface capabilities or computational power.

### BACKGROUND

Although a television may be capable of connecting to the Internet and displaying various web content, many standard, computer-based, content-control techniques may not be suitable for a television platform. For example, when a user wants to display a browser-based widget, also considered a web widget, on a web page, the content provider who provides the web widget may present to the user HyperText Markup Language (HTML) code that the user may cut and paste onto their preferred web page from the content provider's web page. Cutting and pasting using the user-interface mechanisms provided with a television may not be suitable or desirable. Alternatively, some content-provider services may allow a user to outline a region on a source web page and to paste the captured region onto a destination web page. Then, whenever the user displays the destination page, the graphics from the desired region of the source page may be retrieved from the source page for display on the destination page. Again, the outlining and pasting processes may not be suitable for the television platform. Furthermore, this method requires considerable memory and computational power typically not found in a television. Methods and systems that do not require complicated user interfaces, large amounts of memory or computational power for obtaining and managing browser widgets may be desirable.

### SUMMARY

Some embodiments of the present invention comprise methods and systems for obtaining and managing browser widgets using a television remote control. In these embodiments, a television remote control may be used to select, from a widget-catalog web page, a widget to add to a web page. Widget configuration and deletion may be performed using the television remote control to select active regions associated with these functions.

Some embodiments of the present invention comprise methods and systems for obtaining and managing multiple instances of a browser widget. In these embodiments, an instance identifier may be adjoined with a base Uniform Resource Locator (URL), whereby the instance identifier may be associated with a widget instance. In some embodiments of the present invention, instance-specific information associated with the widget may be retrieved from a cookie which may reside on a television. In alternative embodiments of the present invention, instance-specific information associated with the widget may be retrieved from a portal-site server system.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a picture illustrating an exemplary networked system in which embodiments of the present invention may be realized;

FIG. 2 is a picture illustrating an exemplary web page comprising multiple instances of a web widget;

FIG. 3 is a chart showing exemplary embodiments of the present invention comprising dynamic creation of a widget-catalog page;

FIG. 4 is a picture illustrating an exemplary widget-catalog page;

FIG. 5 is a picture illustrating an exemplary widget layout;

FIG. 6 is a picture illustrating a widget size grid;

FIG. 7 is a picture illustrating exemplary widget sizes based on a 3 unit by 3 unit grid;

FIG. 8 is a picture illustrating an exemplary widget-configuration page;

FIG. 9 is a picture illustrating an exemplary portal web page comprising a third-party encapsulated web page;

FIG. 10 is a picture illustrating an exemplary button linking to a web page comprising a third-party encapsulated web page;

FIG. 11 is a chart showing exemplary embodiments of the present invention comprising adjoining an instance parameter and a Uniform Resource Locator (URL); and

FIG. 12 is a chart showing exemplary embodiments of the present invention comprising determining instance-specific widget information by extracting an instance identifier from an instance-adjoined URL.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

Although a television may be capable of connecting to the Internet and displaying various web content, many standard, computer-based, content-control techniques may not be suitable for a television platform. For example, when a user wants to display a browser-based widget, also considered a web widget, on a web page, the content provider who provides the web widget may present to the user HyperText Markup Language (HTML) code that the user may cut and paste onto their preferred web page from the content provider's web page. Cutting and pasting using the user-interface mechanisms provided with a television may not be suitable or desirable. Alternatively, some content-provider services may allow a user to outline a region on a source web page and to paste the captured region onto a destination web page. Then, whenever the user displays the destination page, the graphics from the desired region of the source page may be retrieved from the source page for display on the destination page. Again, the outlining and pasting processes may not be suitable for the television platform. Furthermore, this method requires considerable memory and computational power typically not found in a television. Methods and systems that do not require complicated user interfaces, large amounts of memory or computational power for obtaining and managing browser widgets may be desirable.

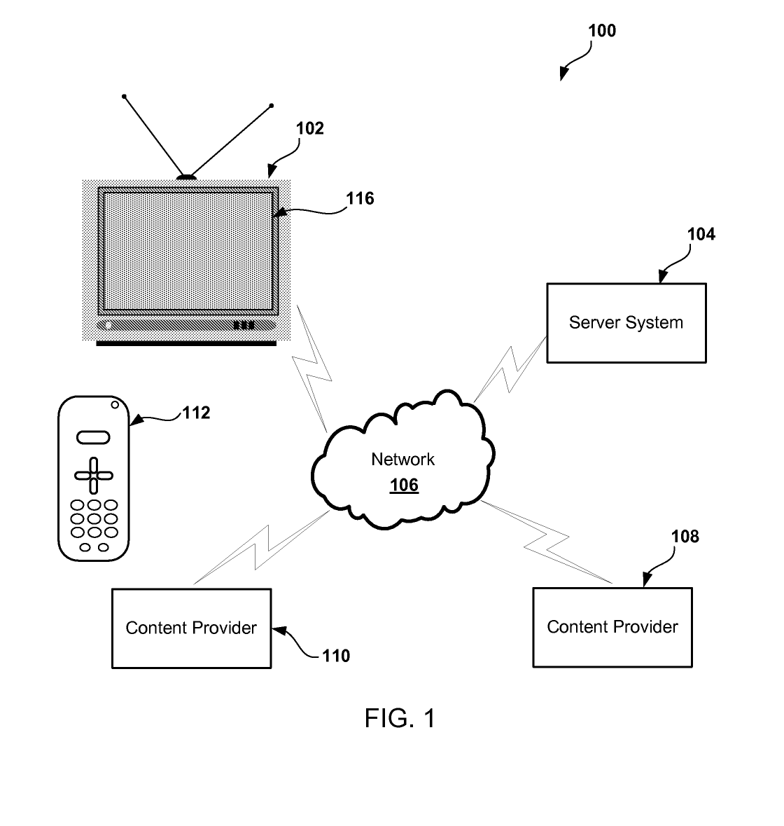

Some embodiments of the present invention comprise methods and systems for obtaining and managing browser widgets using a television remote control. Some embodiments of the present invention comprise methods and systems for obtaining and managing multiple instances of a browser widget. In some embodiments of the present invention, a user may add, delete, configure or view a widget using the user interface of a television remote control. Some of these embodiments of the present invention may be understood in relation to FIG. 1 which depicts a network system 100 in which embodiments of the present invention may be realized. A television 102 may be communicatively coupled with a server system 104 via a network 106 which may provide communication links between various devices, computers and systems within the network system 100. The communication links may be wired or wireless. Third-party content providers (two shown) 108, 110 may be communicatively coupled through the network 106 with the television 102 and/or the server system 104. A remote control device 112 may be associated with the television 102. The television system 102 may comprise a browser and a display 116.

In some embodiments of the present invention, the maximum size of the browser memory (heap) for one web page may be approximately 1 megabyte (MB). In some embodiments of the present invention, the server system 104 may be associated with the manufacturer of the television, a television-service provider or other television-related web site and may be referred to as a portal server system.

In some embodiments of the present invention, the server system 104 may comprise a single server. In alternative embodiments, the server system 104 may comprise multiple servers. In some embodiments, the multiple servers may be located in geographic proximity. In alternative embodiments, the multiple servers may be located in multiple geographic locations. In some embodiments of the present invention, a server system 104 may support portal sites associated with a plurality of countries. In other embodiments of the present invention, a server system 104 may support portal sites in a plurality of languages. In an exemplary embodiment, a server system 104 may support a first portal site in English associated with the United States of America (USA), a second portal site in English associated with Canada and a third portal site in French associated with Canada.

In some embodiments of the present invention, a television 102 may support two browser display modes: a full-screen mode and a split-screen mode. In some embodiments of the present invention, full-screen mode may be associated with web-page viewing only and split-screen mode may be associated with simultaneous web-page viewing and television viewing. In some embodiments of the present invention, horizontal and vertical pixel doubling may be used to create, from original content provided by a content provider, a displayed image in full-screen mode. In alternative embodiments, a full-screen pixel may correspond to 0.6 split-screen pixels in each dimension. In some embodiments of the present invention, in split-screen mode, the size of the displayed content may be identical to the original content.

In some embodiments of the present invention, the television 102 may display content in 12-bit color depth in split-screen mode. In some of these embodiments, 24-bit images may be converted to 12-bit images during image rendering by using the four most-significant bits of each of three color channels, also considered color components. In some embodiments of the present invention, the color components may correspond to red, green and blue. In some embodiments of the present invention, 24-bit color images may be displayed in full-screen mode.

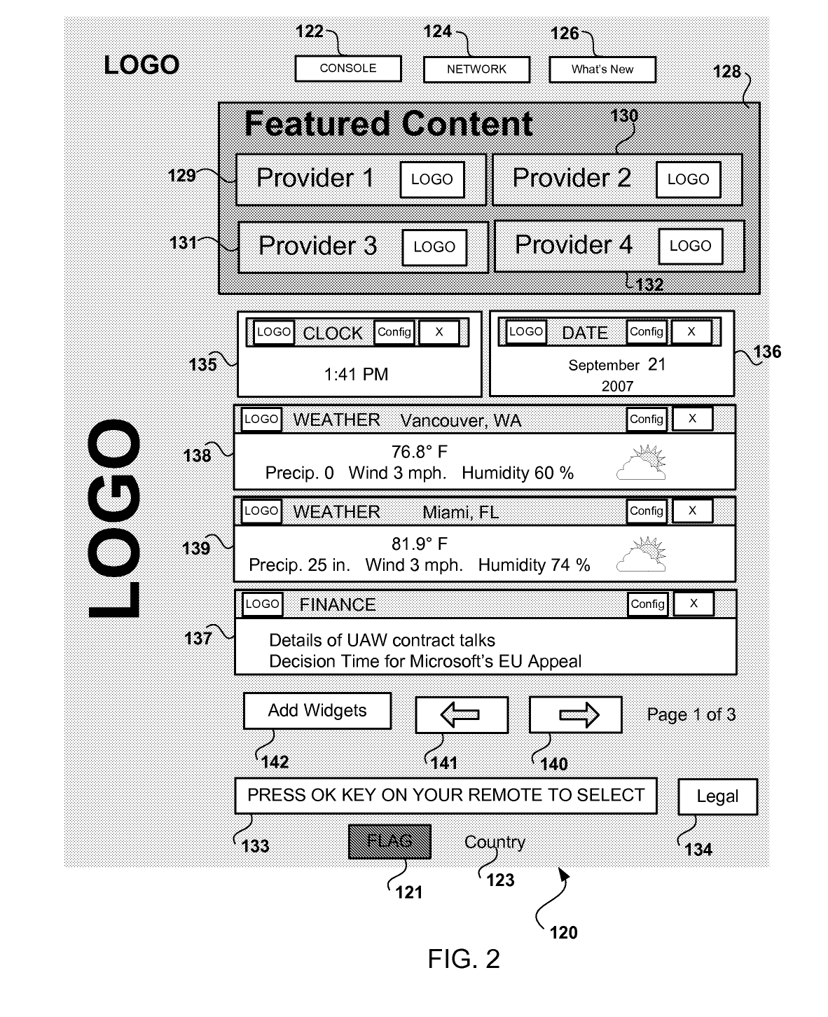

Some embodiments of the present invention may be understood in relation to FIG. 2. FIG. 2 depicts an exemplary portal web page 120 associated with a networked television 102 and a portal server system 104.

In some embodiments of the present invention, a country indicator 121 may be displayed on the portal web page 120, wherein the country indicator 121 may indicate the country associated with the portal server system 104. In some embodiments of the present invention, the country indicator 121 may be an iconic version of the flag associated with the country.

In some embodiments of the present invention, a “country” link 123 may be positioned proximate to the country indicator 121, and when the country link 123 is activated, a configuration page may be displayed, wherein a user may selected a country and/or a language.

In some embodiments of the present invention, once a selection has been made, a user may only have access to the portal site associated with the selection, and the country indicator 121 may be updated to reflect the selection.

In some embodiments of the present invention, portal sites may be consistent across all supported language and countries. For example, the general look, feel and organization of each portal site may be the same. The sites may reflect, between the sites, only differences related to the region associated with a site. In some embodiments, the technical requirements for widgets and web pages accessed through a portal site may be the same, irrespective of the language or country associated with the site. In some embodiments of the present invention, each of the country/language sites may be managed as a separate environment.

In some embodiments, a user may select the country/language site applicable to their location and language preference, but the unique settings made on a specific site may not be transferred to another site when the user reconfigures the country/language setting.

In some embodiments of the present invention, one or more portions (three shown) 122, 124, 126 of the portal web page 120 may be associated with a portal site associated with the server system 104. Other portions (one shown) 128 of the portal web page 120 may be associated with featured-content links 129-132 to featured content. In some embodiments of the present invention, the featured content may be provided by a third party. Still other portions (five shown) may be associated with web widgets 135-139. In some embodiments of the present invention, a web widget may be provided by a third party. The portal web page 120 may also comprise regions (two shown) associated with navigation 140, 141. In some embodiments of the present invention, a user may page through the displayed web widgets using the navigation arrows 140, 141. In some embodiments of the present invention, the portal web page 120 may comprise a button 142 associated with adding a web widget. In some embodiments of the present invention, a web widget may have multiple instances. For example, the exemplary portal web page 120 depicted in FIG. 2 comprises two weather widgets 138, 139, wherein each instance may be associated with different parameters. The exemplary portal web page 120 also comprises a region 133 associated with user instructions and a region 134 associated with legal use information associated with system products. It is understood that the web page 120 depicted in FIG. 2 is an example of a web page related to embodiments of the present invention and is intended for illustration and not limitation.

In some embodiments of the present invention, the television remote control 112 may be used to interact with a web page 120 shown on the television 102.

In some embodiments of the present invention, a user may customize and configure a web page on a television 102. In some embodiments, customization may comprise selecting a web widget for display on a web page on the television 102. In these embodiments, a user may access a catalog of available widgets by invoking an “add widget” function. In some embodiments of the present invention, an available widget may be a third-party-provided web widget. In some embodiments of the present invention, the “add widget” function may be invoked via an “Add Widgets” button 142 on a portal web page 120. In some embodiments of the present invention, the television remote control 112 may be used to activate the “Add Widgets” button 142 on the portal web page 120 displayed on the television display 116.

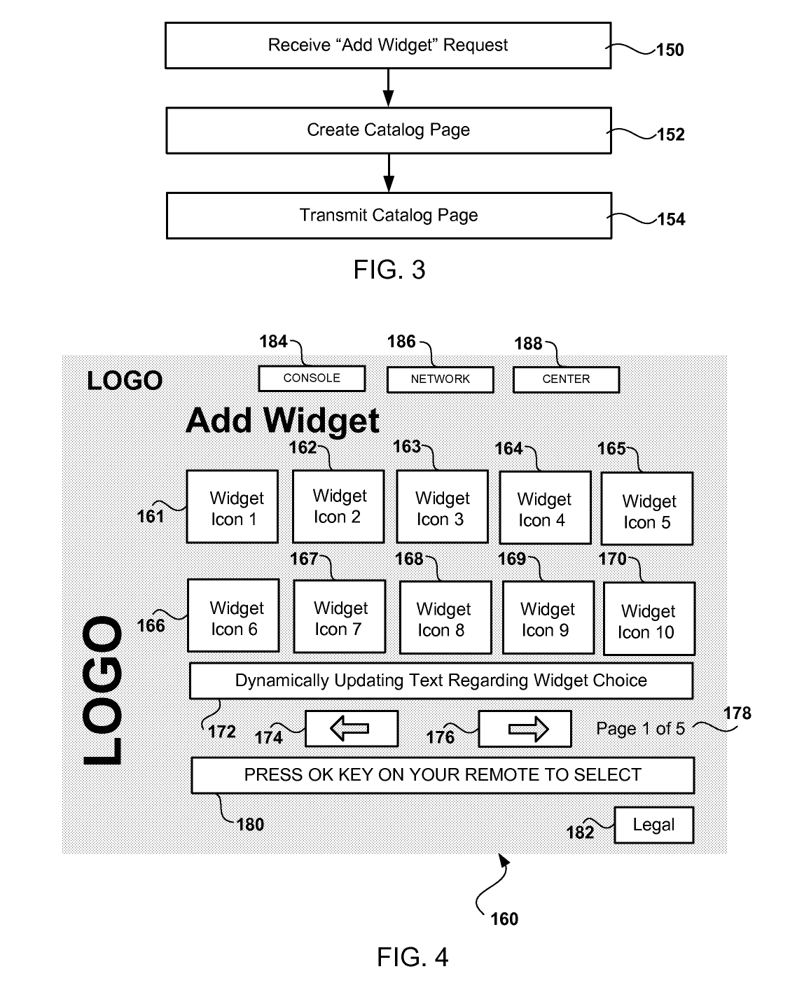

In some embodiments of the present invention described in relation to FIG. 1 and FIG. 3, the server system 104 may maintain a catalog of available widgets, and the server system 104, upon receipt 150 of an “add widget” request from the television 102 browser, may dynamically create 152 a catalog page which may be communicated 154 to the television 102. At the television 102, the catalog page may be displayed, and a user may use the television remote control 112 to navigate through the catalog page and to select a widget to add to the portal web page. In some embodiments of the present invention, the content provider associated with the selected widget may not be called until the widget is displayed for the first time on the portal web page. In alternative embodiments, the content provider may be called upon selection of the widget.

In some embodiments of the present invention, a widget catalog page may be used to add a web widget to a portal web page. FIG. 4 depicts an exemplary catalog page 160 comprising ten 161-170 catalog-page widget icons associated with ten available web widgets. A catalog web page may comprise a text region which may display descriptive text in relation to a selected widget icon. In the exemplary catalog page 160 one such text region 172 is depicted. A catalog web page may comprise navigation widgets which may be used to navigate to additional catalog pages. The exemplary catalog page 160 depicts two navigation widgets 174, 176 which may be used to navigate to additional pages of the catalog. The number of pages available in the catalog may be indicated on a catalog web page as shown 178 in the exemplary catalog web page 160. A catalog page may comprise additional regions associated with instructions for the user (as shown 180 in the exemplary catalog web page 160), legal use (as shown 182 in the exemplary catalog web page 160), return to the portal web page (as shown 184 in the exemplary catalog web page 160) and navigation to other server system related sites (as shown 186, 188 in the exemplary catalog web page 160). It is understood that the catalog web page 160 depicted in FIG. 4 is an example of a catalog web page related to embodiments of the present invention and is intended for illustration and not limitation.

In some embodiments of the present invention, a catalog-page widget icon may be comprise an icon portion, title portion and description portion which may be set by <CatalogIcon>, <Title> and <Description> parameters, respectively. In some embodiments of the present invention, a provider of the widget associated with the catalog-page widget icon may define the catalog-page widget icon parameters in a service-start file associate with the widget. The service-start file may comprise configuration information required to deploy the widget onto the portal site server system 104. In some embodiments of the present invention, the server system 104 may maintain and process all service-start files.

In some embodiments of the present invention, a <CatalogIcon> parameter associated with a catalog-page widget icon may point to a GIF file, wherein the size of a full-screen icon may be 95 pixels by 75 pixels and the size of a split-screen icon may be 140 pixels by 105 pixels. In alternative embodiments, other image file formats and sizes may be used. In some embodiments of the present invention, the catalog-page widget icon may be limited to a white or transparent background. In alternative embodiments of the present invention, the catalog-page widget icon background color may not be limited to white or transparent.

In some embodiments of the present invention, a <Description> parameter associated with a catalog-page widget icon may comprise a text string. In some exemplary embodiments, the text string may have a maximum length of 100 characters, and the text string may provide a user with a brief description of the associated widget. In alternative exemplary embodiments, the text string may have a maximum length of 87 characters. In some embodiments of the present invention, when a user navigates through the widget catalog and focuses on a catalog-page widget icon, the <Description> parameter may be used to update a description portion of the catalog web page, for example the portion 172 shown on the exemplary catalog web page 160 in FIG. 4.

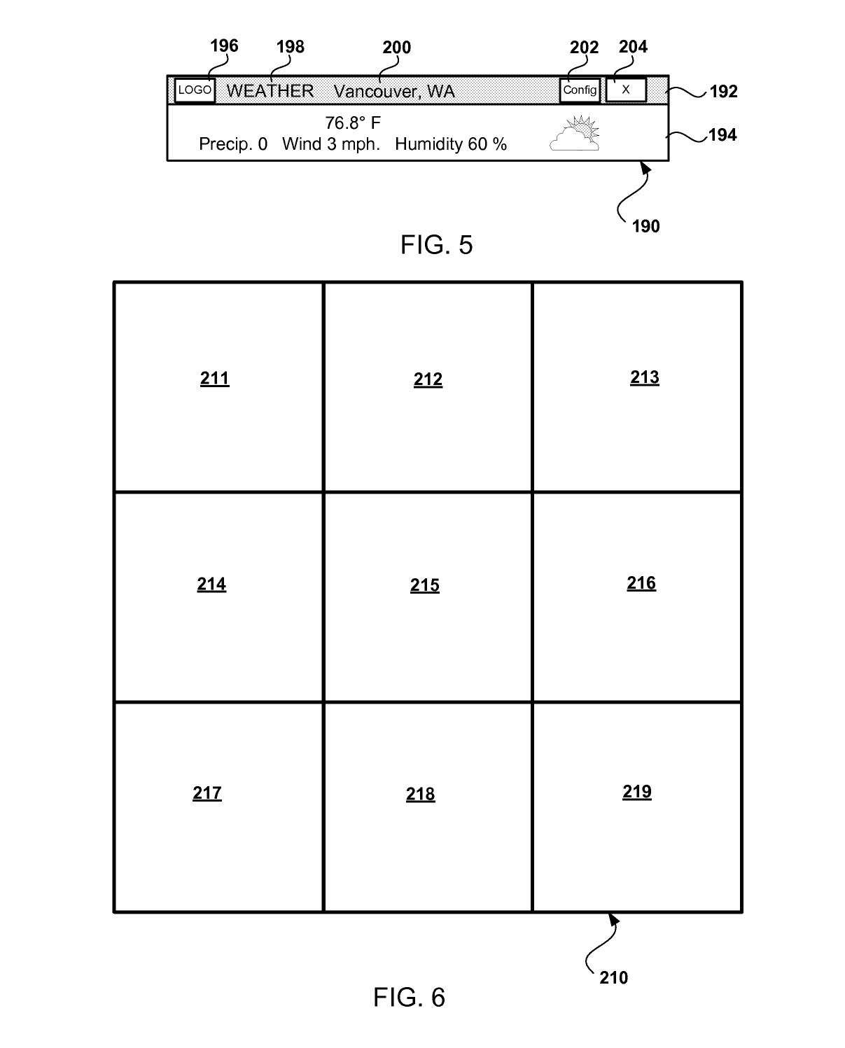

Some embodiments of the present invention may be described in relation to FIG. 5 which depicts an exemplary web widget according to these embodiments. In some embodiments of the present invention, a widget 190 may comprise a banner area 192 and a content-provider-content area 194. The banner area 192 may comprise regions associated with the widget icon 196, the widget title 198, the widget label 200, a configure button 202 and a delete button 204. In these embodiments, the widget-banner content may be generated automatically by the server system 104 from information stored on the server system 104 and the television 102. In some embodiments of the present invention, the information may be stored in a web cookie on the television 102. In alternative embodiments, the information may be stored in a database associated with the server system 104. In some embodiments of the present invention, the widget title 198 may be determined using the <Title> parameter associated with the catalog-page widget icon. The content-provider-content area 194 may be an I-frame within the widget frame. The portal web page may contain a call to the widget on the content provider's server to render the content for the content-provider-content area 194. In some embodiments of the present invention, the content-provider content may be rendered by a call to a <DisplayURL> Uniform Resource Locator (URL) on the content provider's server.

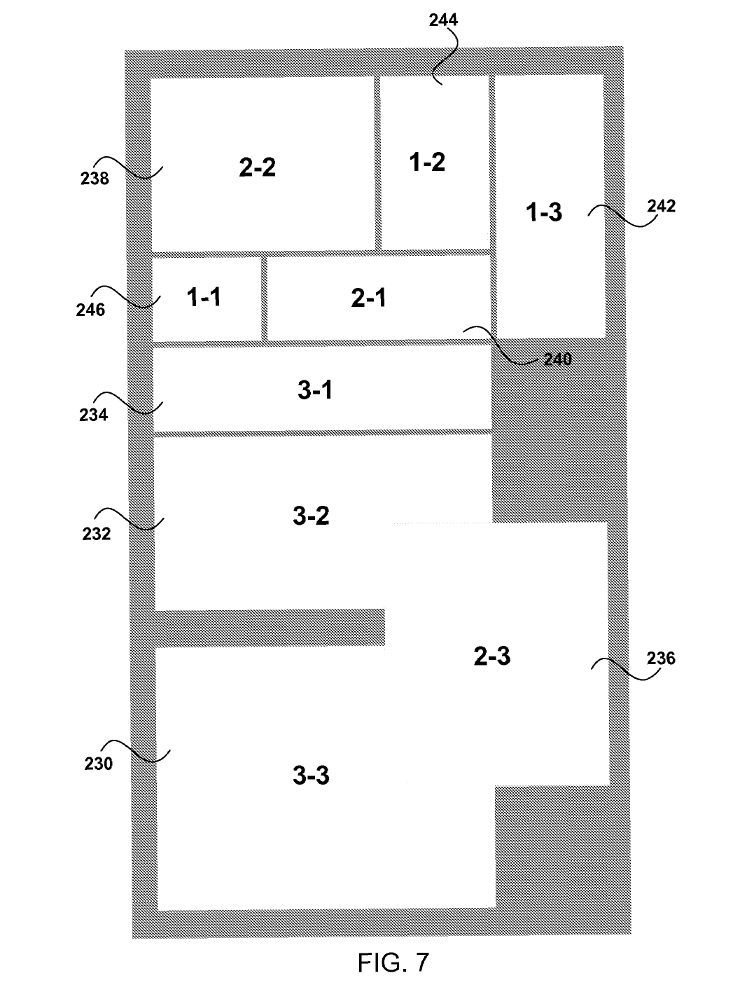

In some embodiments of the present invention, a portal web page may support a number of possible widget display sizes. In some embodiments of the present invention, the supported sizes may be based on a three-by-three grid 210 which may be described in relation to FIG. 6. A widget display size may be an integral number of grid units (211-219) in each dimension. Thus for a three-by-three grid 210 as depicted in FIG. 6, nine widget display sizes may be supported as depicted in FIG. 7. Indicating the sizes as mm, where m denotes the number of grid units in the horizontal direction and n denotes the number of grid units in the vertical direction, the possible sizes are: 3-3 230, 3-2 232, 3-1 234, 2-3 236, 2-2 238, 2-1 240, 1-3 242, 1-2 244 and 1-1 246.

In some embodiments of the present invention, a content provider may provide a web widget with a display size of any of the supported sizes. In some embodiments of the present invention, the widget display size may be included in the service-start file associated with the web widget provided by the content provider via a <Dimension> field in grid units. In some of these embodiments, the content provider may be required to serve content that fits within predetermined pixel dimensions for the value provided in the service-start file. In alternative embodiments, the server system 104 may resize the content served by the content provider. In some embodiments of the present invention, the dimensions may be defined according to Table 1 for full-screen content-provider area and split-screen content-provider areas.

The content-provider-content area may be implemented as an I-frame inside a widget frame. For some embodiments of the present invention, Table 1 may indicate the maximum size of the content-provider-content area for each widget frame for split-screen and full-screen display modes. In some embodiments of the present invention, the content may be rendered by a call to the <DisplayURL> URL on the content provider's server. The service-start file associated with a web widget may allow different <DisplayURL> URLs for each view mode. The call may contain widget-instance-specific information to enable custom configuration of an individual widget instance.

TABLE 1
Widget Component Display Sizes

| Widget Grid Units | | Full Screen CP Area | | Split Screen CP Area | |
|---|---|---|---|---|---|
| Width | Height | Width | Height | Width | Height |
| (grid units) | (grid units) | (pixels) | (pixels) | (pixels) | (pixels) |
| 3 | 3 | 436 | 310 | 730 | 518 |
| 3 | 2 | 436 | 194 | 730 | 324 |
| 3 | 1 | 436 | 78 | 730 | 130 |
| 2 | 3 | 288 | 310 | 482 | 518 |
| 2 | 2 | 288 | 194 | 482 | 324 |
| 2 | 1 | 288 | 78 | 482 | 130 |
| 1 | 3 | 140 | 310 | 234 | 518 |
| 1 | 2 | 140 | 194 | 234 | 324 |
| 1 | 1 | 140 | 78 | 234 | 130 |

The banner area 192 of a web widget 190 may comprise an icon 196, title 198, label 200, “configure” button 202 and “delete” button 204. The icon parameter may be a fixed value which may be set by a <DisplayIcon> field of the service-start file associated with the web widget 190. The icon parameter may point to a GIF file or other image file. In some embodiments of the present invention, the icon 196 may be limited to having a white or transparent background. In alternative embodiments, the background may be any color. In some embodiments, the icon size may be limited based on the display mode. Exemplary sizes may be 22 pixels by 22 pixels for full-screen mode and 38 pixels by 38 pixels for split-screen mode.

The banner area 192 title 198 may be a fixed value which may be set by a <Title> field of the service-start file associated with the web widget 190. The parameter may be a text string. The banner area 192 label 200 may comprise a run-time configurable value which may identify a specific widget instance. In some embodiments of the present invention, the default value of the label parameter may be set by the <Label> field of the service start field associated with the web widget 190. The value may be updated at run time by calling a saveConfiguration URL. The label parameter may be a text string.

In some embodiments, a content provider may be required to confirm that their selected title and label fit in the banner area of the widget that fits their content. In alternative embodiments of the present invention, the server system may resize the title and label to fit in the banner area of the widget.

When the “configure” button 202 is activated, the browser may load an encapsulated widget-configuration page. In some embodiments of the present invention, the television remote control may be used for browser navigation, and may, therefore, activate the configure button 202. A content provider's widget-configuration page may be loaded by a call to a <ConfigureURL> URL on the content provider's server. In some embodiments, the call may contain widget-instance specific information to enable custom configuration of an individual widget instance.

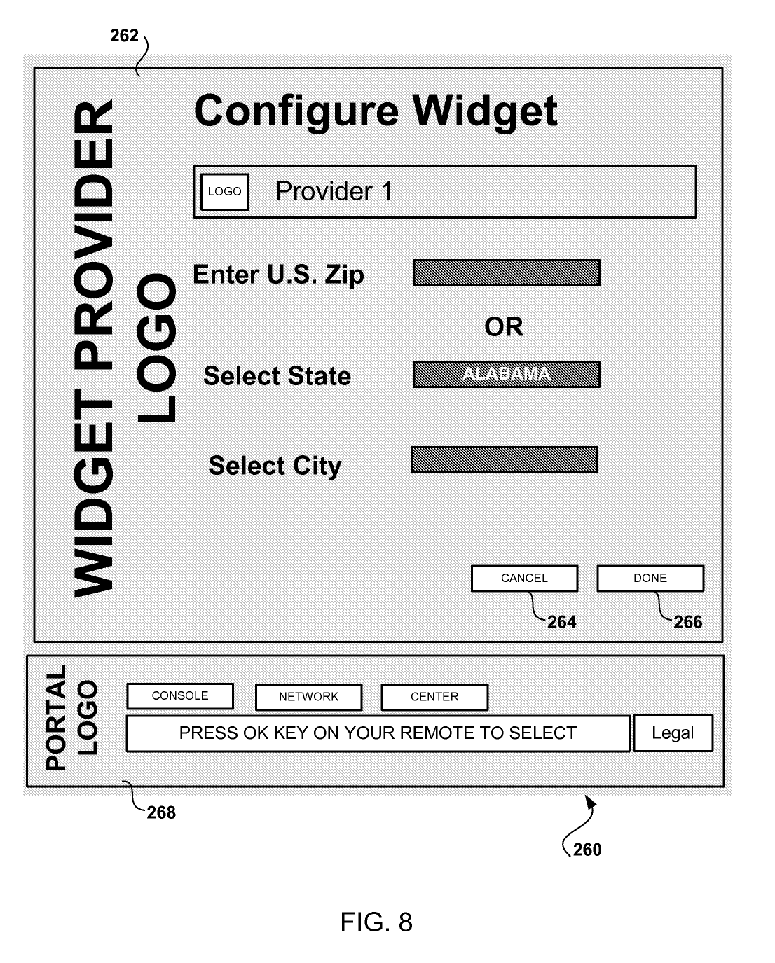

In some embodiments of the present invention described in relation to FIG. 8, a web widget may be configured using an encapsulated widget-configuration page 260. In some embodiments, most of the web page 260 may be dedicated to the content provider's configuration content 262, while a small portion 268 may be retained by the server system to allow ease of navigation of the portal site. In some embodiments of the present invention, the content provider's content may be encapsulated into the web page using an I-frame. In some embodiments of the present invention, the size of the content-provider area may be limited. Exemplary sizes may be 953 pixels by 435 pixels for full-screen mode and 953 pixels by 936 pixels for split-screen mode. In some embodiments of the present invention, the content-provider area for the full-screen mode and the split-screen mode may be based on the 8% rule for frame size. In alternative embodiments of the present invention, the content-provider area for the modes may be based on the 10% rule for frame size.

In some embodiments of the present invention, a “cancel” button 264 and a “done” button 266 may be required to be provided by the content provider in order to provide exit functionality from the widget-configuration area.

In some embodiments of the present invention, when the “done” button 266 is activated, the content provider's configuration page may execute the following operations in the order listed:
1. Save any content-provider-specific configuration data to the content provider's server and/or cookies, if needed.
2. Call a portal-site-associated saveConfiguration URL.

In response to a saveConfiguration URL call, the instance configuration for the widget may be saved at the server system, if needed, and the portal web page may be loaded using the new configuration of the widget.

When the “cancel” button 264 is activated, the content provider's configuration page may call a displayPortal URL to return to the portal web page, and the widget's configuration data may not be changed.

Addition of a content-provider's content to a site may be done independently for each site. In some embodiments of the present invention, a content provider may submit a single service-start file which may be applicable for multiple sites. In these embodiments, a specific site, or sites, must be indicated when submitting content to a server system.

In some embodiments of the present invention, a user may select the country/language site applicable to their location and language preference, but the unique settings made on a specific site may not be transferred to another site when the user reconfigures the country/language setting. In these embodiments, a widget added to a console page on one site will not be seen on the console page of another site.

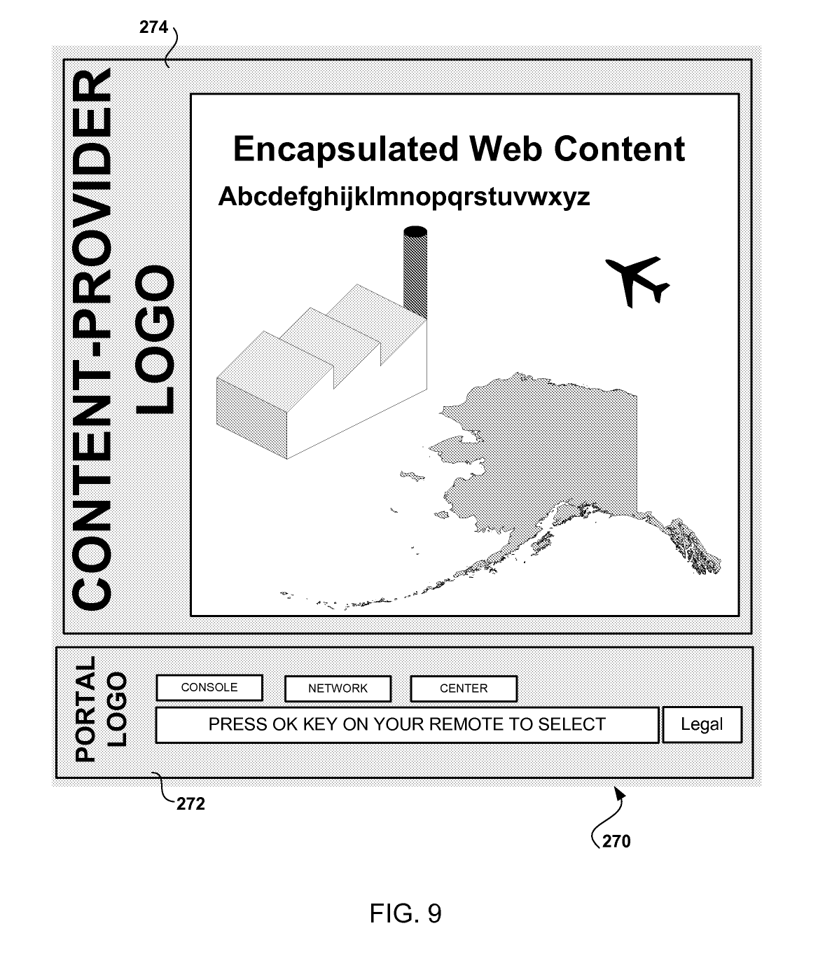

In some embodiments of the present invention, content providers may provide web pages developed for a networked television. In some of these embodiments of the present invention, third-party content providers may provide web pages developed for the networked television. Links on the portal page may provide access to featured web pages. In the exemplary portal page 120 depicted in FIG. 2, four links 129-132 are depicted. FIG. 9 depicts an exemplary portal page 270 comprising a third-party-developed web page 274. In some embodiments of the present invention, a small portion 272 of the portal page 270 may be retained by the portal site server to allow easy portal site navigation by a user. The third-party content may be encapsulated into the portal page 270 using an I-frame. In some embodiments of the present invention, the content-provider area may be 953 pixels by 435 pixels in full-screen mode and 953 pixels by 936 pixels in split-screen mode. Some embodiments of the present invention may comprise a template for the encapsulating page. In some embodiments of the present invention, encapsulated web pages may be rendered by a call to an encapsulateWebPage URL.

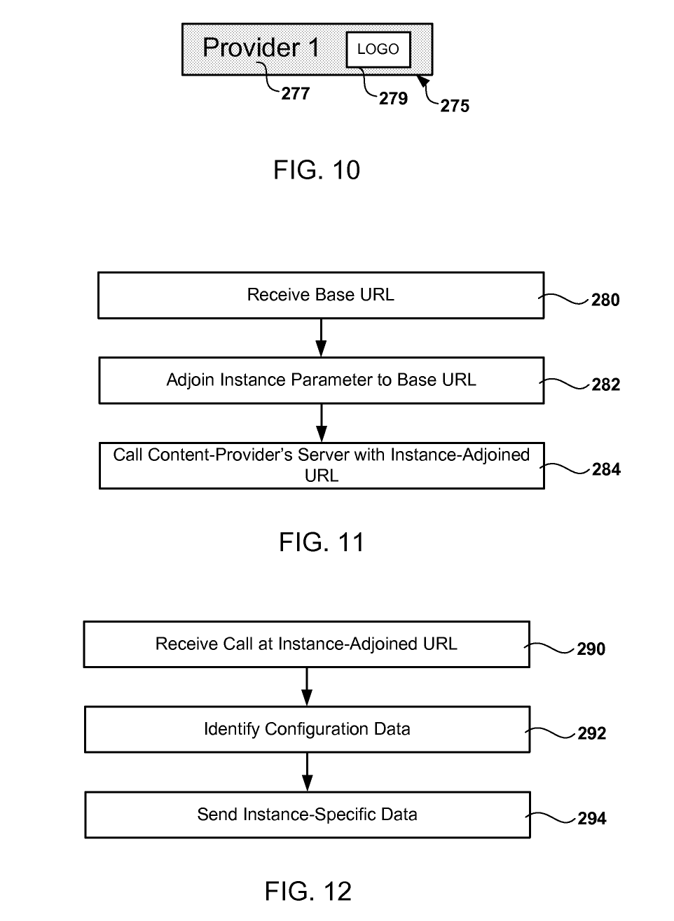

Some embodiments of the present invention described in relation to FIG. 10 may comprise a button link to a web page. In these embodiments a button 275 may be used for all web-page links. The portal page server may automatically generate a button from information read from a web page's service-start file during service deployment. In some embodiments of the present invention, each button 275 comprises an icon 279 and a title 277 which may be set by the parameters <DisplayIcon> and <Title>, respectively, in the associated page's service-start file. In an exemplary embodiment of the present invention, the <DisplayIcon> parameter points to a GIF file, the full-screen mode icon size is 56 pixels by 27 pixels, the split-screen mode icon size is 68 pixels by 33 pixels, and the <Title> parameter is a text string that has maximum length of ten characters. In alternative embodiments, different image file formats and sizes may be used. In still alternative embodiments, when a <Title> parameter is not provided, the icon 279 associated with the <DisplayIcon> parameter may be resized to fill a more substantial portion of the button 275 display area than when a <Title> parameter is provided.

In some embodiments of the present invention, a plurality of URLs may be provided by a content provider in order to allow their content to be integrated into a portal server site. In some embodiments of the present invention comprising a NetFront Browser, the maximum length of a URL may be 256 bytes.

In some embodiments of the present invention described in relation to FIG. 11, a server system may receive a base URL 280. The server system may adjoin 282 an instance parameter, Instance, associated with a widget and the base URL at run time to identify which instance of a widget should be referenced, thereby producing an instance-adjoined URL. In some embodiments of the present invention, the server system may append the instance parameter to the base URL. The server may then call 284 the content provider's server with the resultant instance-adjoined URL. In some embodiments of the present invention, an HTTP GET request may be used to call 284 the content provider's server.

In some embodiments of the present invention, the instance parameter may be assigned by a server system to a widget instance when a user initially adds, to their widget collection, a content provider's widget. In these embodiments, the instance parameter may be guaranteed to be unique across all widgets and instances, and it may not change during the lifetime of the widget.

In some embodiments of the present invention, a unique base URL for each country/language site where the associated content may be installed may be required if the operation of the content is different between sites.

In some embodiments of the present invention, a host parameter, Host, indicating the host-name of the portal site that sent a request to a content-provider's server may be adjoined to the base URL.

In some embodiments of the present invention, both a host parameter and an instance parameter may be adjoined to the base URL.

In some embodiments of the present invention described in relation to FIG. 12, a content provider may receive 290 a call at a URL with the adjoined instance parameter. The content provider may identify 292 instance configuration data using the instance parameter, and the content provider may send 294 instance-specific data in response to the call. In some embodiments of the present invention, the instance-specific configuration data may be stored in a cookie on the television. In alternative embodiments of the present invention, the configuration data may be stored on a database on the content provider's server. In yet alternative embodiments of the present invention, the configuration data may be stored on a database associated with the server system. In some embodiments of the present invention, the configuration data may be apportioned between any or all of the television using cookies, the content provider's server and the portal server system. The following comprises an exemplary instance-adjoined, also considered complete, URL:

http://example.com/widget/display.asp?Device=TV&Font=Verdana&Zip=97607&Days=5&Instance=123. The following comprises an exemplary instance-and-host-adjoined, also considered complete, URL:

http://example.com/widget/display.asp?Device=TV&Font=Verdana&Zip=97607&Days=5&Instance=123&Host=www.aquos.net.

In some embodiments of the present invention, a content provider may provide a ConfigureURL URL which may be called to load the content provider's widget-configuration page. The base URL for the ConfigureURL may be provided by a <ConfigureURL> parameter of the service-start file associated with the widget. If a widget is not configurable, there may not be an associated ConfigureURL URL. The following comprises an exemplary base URL which may be provided by a content provider:

http://example.com/widget/configure.aspx?Device=TV.

When this URL is called, the server system may adjoin the instance parameter, along with any additional parameters that may have been previously passed to the server system, and the base URL. In some embodiments, the server system may append the instance parameter along with any addition parameters to the base URL. The following comprises an exemplary complete URL:

http://example.com/widget/configure.aspx?Device=TV&Zip=97607&Days=5&Instance=123. Another exemplary complete URL may be:

http://example.com/widget/configure.aspx?Device=TV&Zip=97607&Days=5&Instance=123&Host=www.aquos.net.

In some embodiments of the present invention, a content provider may provide a DeleteURL URL which may be called to delete a web widget. In some embodiments of the present invention, when this URL is called, the content provider may display a deletion dialog box in their widget area. The deletion dialog box may allow a user to delete the widget from their widget collection. If the user selects to delete the widget, the third-party content provider may delete the instance configuration. In some embodiments of the present invention, the instance configuration may be maintained on the content provider's server. In alternative embodiments, the configuration instance may be maintained in cookies on the television. In yet alternative embodiments, the configuration instance may be maintained on the portal server system. In some embodiments, the configuration instance may be apportioned between any or all of the content provider's server, the television using cookies and the portal server system. The content provider may then call deleteWidget URL with a target of_top, thereby causing the browser to load the deleteWidget URL in the topmost frame. The portal server system may delete its instance-specific information for that widget from its server and display the portal page with the widget removed. If the configuration instance is maintained on the television using a cookie, then the cookie may be updated to delete the instance. The cookie may remain with configuration information associated with other instances of the widget. If no additional instances remain, the cookie may be deleted. In some embodiments, if the user chooses not to delete the widget, then the content provider may exit by displaying the widget within the widget area. The base URL for the DeleteURL may be provided by the <DeleteURL> parameter of the widget's service-start file. An exemplary base URL may be:

http://example.com/widget/delete.php ?Device=TV.

When this URL is called, the portal server system may adjoin the Instance parameter and the Host parameter to the base URL, thereby generating the exemplary complete URL:

http://example.com/widget/delete.php?Device=TV&Instance=123&Host=www.aquos.net comprising both an instance parameter value and a host parameter value. In some embodiments, only the Instance parameter or the Host parameter may be adjoined to the base URL.

In some embodiments of the present invention, a content provider may provide a DisplayURL URL which may be called to display a widget. In some embodiments of the present invention, the base URL for the Display URL may be provided in the <DisplayURL> parameter of the service-start file associated with the widget. An exemplary base URL may be:

http://example.com/widget/display.asp ?Device=TV&Font=Verdana.

When this URL is called, the portal server system may adjoin the instance parameter and the host parameter, along with any parameters than may have been previously passed to the server, and the URL, thereby producing a complete URL. In some embodiments, parameters may have been previously passed through saveConfiguration URL. An exemplary complete URL may be:

http://example.com/widget/display.asp?Device=TV&Font=Verdana&Zip=97607&Days=5&Instance=123&Host=www.aquos.net.

In some embodiments of the present invention, a plurality of URLs may be provided to a content provider for use in interacting with the portal site. In the following exemplary URLs <PortalServer> is an exemplary host name of the server. In some embodiments, a content provider may build a URL dynamically using the host name of the site currently accessing a widget. This may be taken from the host, Host, parameter which may be adjoined with the base URL of the request. In some embodiments, this may be accomplished by obtaining the host name from the “referrer” header sent with the request to the content provider's server.

A deleteWidgetInstance URL may be provided to complete the deletion of an identified widget instance and to load a portal web page. In some embodiments of the present invention, this URL may be called when a user affirms a delete-widget selection. An exemplary URL may be given by:

http://<PortalServer>/PortalActions/deleteWidgetInstance?Instance=123,

where the required Instance parameter may identify the widget instance being deleted.

A displayPortal URL may load the portal web page with the identified widget display in the page's widget area. This URL may be called to return to the portal page from a content provider's widget-configuration page if a user cancels out of the configuration step. This URL may be called after the completion of the configuration of a widget if the content provider is storing the configuration data in cookies or on their own server. An exemplary URL may be given by:

http://<PortalServer>/PortalActions/displayPortal?Instance=123,

where the server system may load, in some embodiments of the present invention, the portal web page with the widget specified by the optional Instance parameter displayed in the widget area. In some embodiments of the present invention, if the optional Instance parameter is not specified, then the first page of widgets in a user's collection may be displayed.

An encapsulateWebPage URL may load a content provider's web page that may be encapsulated within a portal web page. An exemplary URL may be given by:

http://<PortalServer>/PortalActions/encapsulateWebPage?insideurl=http%3A%2F%2Fex ample.com%2Fwebpage.html,

where the required parameter insideurl may comprise the URL of the web page to be encapsulated and the optional parameter title may comprise the title of the web page to be encapsulated.

A saveConfiguration URL may update a widget's instance-specific configuration parameters and may load the portal page with the identified widget display. An exemplary URL may be given by:

http://<PortalServer>/PortalActions/saveConfiguration?Instance=123&Label=Camas&Zi p=98607&Days=5,

where the required Instance parameter may identify the widget instance being configured and the optional label parameter may set the banner area label for the widget instance. Other parameters may be content-provider specific and may be stored and passed back to the content provider whenever the widget instance is loaded. For example, the next time this widget instance is loaded, the executed URL may be:

http://example.com/widget/display.asp ?Device=TV&Zip=98607&Days=5&Instance=123 where the Zip parameter and Days parameter may be determined from stored information associated with the widget instance. In some embodiments of the present invention, when a widget configuration is saved, the previous instance-specific, content-provider-specific parameters may be deleted and the new parameters may be recorded for use with subsequent widget loading.

In some embodiments of the present invention, a plurality of APIs may be provided for content-provider use. A checkDisplayMode function may check a mode passed as a parameter against the mode returned by a getDisplayMode function. If the modes do not match, an alternate URL may be loaded. In some embodiments of the present invention, a content provider may call this function directly if needed. In alternative embodiments, a content provider may call a startDisplayModeCheck to have it checked automatically. An exemplary prototype may be:

void checkDisplayMode(String pageMode, String alternateUrl),

where the required parameter pageMode indicates the mode for which the current page is designed which will be checked against the current mode of the television. The required parameter alternateUrl indicates the URL to load if the modes are determined to be different.

The getDisplayMode function may return the current display mode of the television, for example, full-screen mode or split-screen mode. The content provider may use this API to detect if the user has changed the television's screen mode. The content provider may redraw their content for the appropriate screen mode. In some embodiments of the present invention, a content provider may call this function directly. In alternative embodiments, a content provider may call the startDisplayModeCheck to have it checked automatically. An exemplary prototype may be:

String getDisplayMode(void),

where possible return values may be fullview indicating for full-screen mode and splitview indicating split-screen mode.

The startDisplayModeCheck function may start a recurring call to checkDisplayMode. The content provider may call this function when their web page loads to have an alternate page be loaded if the user changes the display mode while viewing the page. An exemplary prototype and return values may be:

void startDisplayModeCheck(String pageMode, String alternateUrl, Integer interval), where the required parameter pageMode indicates the mode for which the current page is designed which will be checked against the current mode of the television. The required parameter alternateUrl indicates the URL to load if the modes are determined to be different, and the optional parameter interval indicates the number of milliseconds between checks.

Some embodiments of the present invention may comprise service control files which may be provided by a content provider to a portal server system to start, update and terminate a widget or web page service. In some embodiments of the present invention, the service control files may comprise XML (eXtensible Markup Language) files. In some embodiments of the present invention, a <Provider> parameter may be used to identify the content provider. In some embodiments of the present invention, the value may be assigned to the content provider by the server system. In some embodiments of the present invention, a <ContentID> parameter may be unique in the domain of the content provider for all content delivered to the server system. In some embodiments, the content provider may assign this parameter value themselves.

Some embodiments of the present invention may comprise a service-start file. The service-start file may be used to deliver a new service to a portal server system and to update an existing service. In some embodiments, if the <Provider> and <ContentID> parameters match those of an already existing service, the existing service configuration may be completely overwritten by the new configuration. In these embodiments, none of the parameters of the already existing service may be retained; therefore, the configuration file must completely describe the service. In alternative embodiments, if the <Provider> and <ContentID> parameters match those of an already existing service, only newly provided parameter values may be overwritten. In these embodiments, some parameter of the already existing service may be retained.

Upon receiving a service-start file, a portal-site administrator may enter the service into the portal-site service database, test the service to verify that it is functional and then deploy the service if it operates successfully. Upon deployment, the service may be available on the portal site to all users. In some embodiments, the service may be advertised on a “What's New” page or other portal web page.

The service-start file may comprise pointers to content and services located on the content provider's server. Therefore, a content provider may update their content and services without the need to send a new service-start file to the portal site server system as long as the parameters in the originally delivered service-start file remain correct for the new version of content and services.

Service-start files may contain unique URLs for the split-screen mode and the full-screen mode, thereby allowing a content provider to have a unique layout for each of the two modes. If the layout is identical for both modes, then a content provider may put the same URL in both fields.

Below is an exemplary SML listing and description for a widget service-start file.

<ServiceStart xmlns:xsi=“http://www.w3.org/2001/XMLSchema-instance”
xsi:noNamespaceSchemaLocation=“http://rps.sharp-
service.com/aquosnet/devsupport/schemas/ServiceStart-v0_8.xsd”>

<Provider>

Content provider name

</Provider>
<ContentID>

Content provider unique ID for this widget

</ContentID>
<CountryLanguage>

CountryLanguageCode {UsEn|CaFr|CaEn} One CountryLanguage

element is mandatory, maximum of three allowed. Each must be unique.
</CountryLanguage>
<PortalPageWidget>

<DisplayModeIndependentData>

<Version>

Content provider start service file version number

</Version>
<MaximumInstances>

Optional: Maximum number of instances allowed. Must be greater
than or equal to 1. May have the value “UnBounded”, which is also
the default.

</MaximumInstances>
<Title>

Title of widget

</Title>
<Label>

Default label for of widget

</Label>
<Description>

Widget description displayed on widget catalog page

</Description>
<Dimensions>

<Height>

Height of widget in grid units(1 to 3)

</Height>
<Width>

Width of widget in grid units(1 to 3)

</Width>

</Dimensions>

</DisplayModeIndependentData>
<FullScreenModeData>

<DisplayURL>

Base URL for displaying the widget

</DisplayURL>
<ConfigureURL>

Optional: Base URL for configuring the widget

</ConfigureURL >
<DeleteURL>

Base URL for deleting the widget

</DeleteURL>
<DisplayIcon>

Path to icon used on AQUOS Console page

</DisplayIcon>
<CatalogIcon>

Path to icon used on Widget Catalog page

</CatalogIcon >
</FullScreenModeData>

<SplitScreenModeData>

<DisplayURL>

Base URL for displaying the widget

</DisplayURL>
<ConfigureURL>

Optional: Base URL for configuring the widget

</ConfigureURL >
<DeleteURL>

Base URL for deleting the widget

</DeleteURL>
<DisplayIcon>

Path to icon used on AQUOS Console page

</DisplayIcon>
<CatalogIcon>

Path to icon used on Widget Catalog page

</CatalogIcon>

</SplitScreenModeData>

</PortalPageWidget>

</ServiceStart>

Some embodiments of the present invention may comprise a service-terminate file which may be used to terminate an existing service. A content provider may send a service-terminate file to the portal site when they want to discontinue the existing service.

Upon receiving a service-terminate file, a portal-site administrator may load the file into a portal-site service database. The database system may cross reference the <Provider> and <ContentID> parameters of the service-terminate file with the services currently deployed and may remove the identified service from all portal sites identified in the original service-start file. After termination, the service may no longer appear on any user's television.

Below is listed the XML for an exemplary service-terminate file and its description.

<ServiceTerminate xsi:noNamespaceSchemaLocation=“http://rps.sharp-
service.com/aquosnet/devsupport/schemas/ServiceTerminate-v1_0.xsd”
xmlns:xsi=“http://www.w3.org/2001/XMLSchema-instance”>>

<Provider>

Content provider name

</Provider>
<ContentID>

Content provider unique ID for this widget

</ContentID>

</ServiceTerminate>

In some embodiments of the present invention, separate HTML may be used for rendering full-screen pages and split-screen pages.

Some embodiments of the present invention may comprise cookies with the following parameters:

Size: 3840 bytes for each PATH,

Maximum quantity: 1000 pieces,

Maximum quantity for each domain: of 10 pieces, and

Expiration date override: the oldest cookie may be deleted when the number of cookies gets to the maximum number.

Some embodiments of the present invention may comprise web pages provided by a portal site, wherein content providers may announce new services or new-service-related content. A “Coming Soon” page may be available to pre-announce a service before the service is deployed. This ensures that the user is aware of the service and may be looking for the service when it becomes available. A “What's New” page may be available to announce new service availability. When a new “What's New” story is available a red flag may be shown on a “What's New” button on a console page. This red flag may encourage the user to read the story and learn about the new service.

In some embodiments of the present invention, a content provider may submit a “Coming Soon” story for publication on a “Coming Soon” page. Templates and guidelines may be provided to ensure format requirements may be met for the page.

In some embodiments of the present invention, a content provider may submit a “What's New” story for publication on the “What's New” page. Templates and guidelines may be provided to ensure format requirements may be met for the page.

Templates may be provided to allow an author to anticipate how a published story may appear to a user. The released version may not appear exactly as seen in the template, some layout changes may be made by the portal provider before a story may be published on the portal site. Exemplary guidelines may comprise:
1. Must be viewed in print layout mode of Word;
2. Replace text within angle brackets “< . . . >”;
3. Do not modify font type or size (small changes may be made if required);
4. Please try to provide approximately the same amount of text as shown in the template; and
5. Icon sizes shown are suggested only, alternate sizes can be used.

In some embodiments of the present invention, templates may be provided in Word format and may be available on a developer support page.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A method for managing multiple instances of a web widget, said method comprising:
a) receiving a first Uniform Resource Locator (URL) associated with a first widget;
b) generating a first instance identifier; and
c) adjoining said first instance identifier and said first URL, thereby producing an first instance-adjoined URL.

2. A method as described in claim 1 further comprising adjoining a first host identifier to said first instance-adjoined URL, thereby producing a first instance-and-host-adjoined URL.

3. A method as described in claim 1 further comprising associating at least one parameter value with said first instance identifier, wherein said at least one parameter value associated with said first instance identifier is related to said first widget.

4. A method as described in claim 3, wherein said associating at least one parameter value with said first instance identifier comprises generating a first web cookie.

5. A method as described in claim 4, wherein said first web cookie is stored on a television.

6. A method as described in claim 3 further comprising storing said at least one parameter value associated with said first instance identifier in a database associated with a server system.

7. A method as described in claim 1 further comprising calling a content-provider server with said first instance-adjoined URL.

8. A method as described in claim 1 further comprising:
a) generating a second instance identifier; and
b) adjoining said second instance identifier and said first URL, thereby producing a second instance-adjoined URL.

9. A method as described in claim 8 further comprising associating at least one parameter value with said second instance identifier, wherein said at least one parameter value associated with said second instance identifier is related to said first widget.

10. A method as described in claim 9, wherein:
a) said associating at least one parameter value with said first instance identifier comprises generating a first web cookie; and
b) said associating at least one parameter value with said second instance identifier comprises adding said at least one parameter value associated with said second instance identifier to said first web cookie in association with said second instance identifier.

11. A method as described in claim 10, wherein said first cookie is stored on a television.

12. A method as described in claim 9 further comprising:
a) storing said at least one parameter value associated with said first instance identifier in a database associated with a server system; and
b) storing said at least one parameter value associated with said second instance identifier in said database associated with said server system.

13. A method for managing multiple instances of a web widget, said method comprising:
a) receiving a first URL associated with a first widget;
b) extracting a first instance identifier from said first URL; and
c) serving content based on said first widget and said first URL.

14. A method as described in claim 13 further comprising:
a) retrieving at least one parameter value associated with said first instance identifier; and
b) wherein said serving is further based on said at least one parameter value associated with said first instance identifier.

15. A method as described in claim 14, wherein said retrieving at least one parameter value associated with said first instance identifier comprises retrieving a cookie.

16. A method as described in claim 15, wherein said cookie resides on a television.

17. A method as described in claim 14, wherein said retrieving at least one parameter value associated with said first instance identifier comprises requesting said at least one parameter value associated with said first instance identifier from a remote server.

18. A method as described in claim 13, wherein said content is a configuration page associated with said first widget.

19. A method as described in claim 18 further comprising:
a) receiving at least one configuration parameter value related to said first widget; and
b) associating said at least one configuration parameter value with said first instance identifier.

20. A method as described in claim 19, wherein said receiving at least one configuration parameter value related to said first widget is from a television.

21. A method for managing a web widget on a television, said method comprising:
a) receiving a first signal at a television from a remote control device associated with said television, wherein said first signal is associated with an add-widget request;
b) sending a first request to a server system from said television, wherein said first request is associated with said add-widget request;
c) receiving a first rendered page at said television from said server system, wherein said first rendered page comprises a first selectable region associated with a first widget;
d) displaying said first rendered page on said television;
e) receiving a second signal at said television from said remote control device, wherein said second signal is associated with said first selectable region; and
f) sending a second request to said server system from said television, wherein said second request is associated with said first widget.

22. A method as described in claim 21 further comprising receiving a second rendered page at said television from said server system, wherein said second rendered page comprises a configuration page associated with said first widget.
